(19) United States
(12) Patent Application Publication
(10) Pub. No.: US 2026/0113438 A1
(43) Pub. Date: Apr. 23, 2026

(54) AN APPARATUS, A METHOD AND A COMPUTER PROGRAM FOR VIDEO CODING AND DECODING

(71) Applicant: Nokia Technologies Oy, Espoo (FI)

(72) Inventors: Saverio BLASI, London (GB); Jani LAINEMA, Tampere (FI)

(21) Appl. No.: 19/118,715

(22) PCT Filed: Aug. 28, 2023
(86) PCT No.: PCT/FI2023/050492

§ 371 Date: Apr. 4, 2025

(30) Foreign Application Priority Data
Oct. 7, 2022 (FI) 20225909

(51) Int. Cl. H04N 19/11; H04N 19/119; H04N 19/132; H04N 19/167; H04N 19/172; H04N 19/176; H04N 19/463; H04N 19/593

(52) U.S. Cl. CPC H04N 19/11; H04N 19/132; H04N 19/172; H04N 19/176; H04N 19/463; H04N 19/593; H04N 19/119; H04N 19/167

(57) ABSTRACT

There is disclosed a method for location dependent template-based intra mode derivation. In accordance with an embodiment, encoded video data is decoded to obtain reconstructed samples of a picture; the reconstructed samples are used to intra-predict a current block of the picture; an area in a surrounding of the current block is divided (701) into at least two templates formed of the already reconstructed samples at specific locations with respect to the current block; for each template one or more intra-prediction modes are determined (702) by template-based intra mode derivation; at least two predictors of the current block are computed (705) based on the determined intra-prediction modes; and the at least two predictors are combined together using blending by sample-based weights to form (705) a prediction block for the current block.

### TECHNICAL FIELD

The present invention relates to an apparatus, a method and a computer program for video coding and decoding, especially for location dependent template-based intra mode derivation.

### BACKGROUND

Video codec typically comprises an encoder that transforms the input video into a compressed representation suited for storage/transmission and a decoder that can uncompress the compressed video representation back into a viewable form. Typically, encoder discards some information in the original video sequence in order to represent the video in a more compact form (that is, at lower bitrate).

Typical hybrid video codecs encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly, a prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In conventional video codecs, a number of intra-prediction modes are typically made available, typically consisting of different directional intra-prediction modes, as well as conventional prediction modes such as DC or Planar intra-prediction. Conventional codecs allow encoders to search for one optimal mode, where the mode is then signalled in the bitstream. The decoder parses this signalling to recover the correct intra mode to use for the current block, and then forms the intra prediction block accordingly. However, the resulting prediction is often sub-optimal, due to the fact that a template region may not be strongly correlated with the content in the current block.

### SUMMARY

Now in order to at least alleviate the above problems, enhanced methods for producing an intra-prediction for a given block using template-based intra mode derivation (TIMD) techniques in encoders and/or decoders are introduced herein.

Template-based intra mode derivation techniques rely on a region (or template) formed of already reconstructed samples in the surrounding of the current block. Rather than signalling the correct intra mode to use for the current block, an encoder/decoder searches among different intra modes using the samples within the template as a target. Reconstructed samples in the surrounding of the template are used as reference samples. The encoder/decoder performs intra prediction with different modes using the reference samples, and then compares the resulting prediction with the target template, and selects the intra mode that minimizes a pre-defined distortion metric.

TIMD methods can successfully reduce the overhead needed to signal a given intra prediction mode.

There is provided a method for intra-prediction using template-based prediction derivation (TIMD) techniques for a current block, where an area in a surrounding of the current block is divided in a number of at least two templates. Each template is formed of already-reconstructed samples at a specific location with respect to the current block, where a search among a number of candidate intra-prediction modes is performed for each template resulting in one or more selected TIMD intra prediction modes.

According to an embodiment an optimal mode for each template is based on a distortion metric.

According to an embodiment reference samples are used to perform intra-prediction to obtain a predictor for the current block, where the reference samples used depend on a specific template.

According to an embodiment predictors are combined to form a prediction for the current block.

According to an embodiment the combination is formed using sample-based blending.

According to an embodiment distortions obtained for each template are scaled depending on the number of samples in each template.

A method operating according to some embodiments comprises forming predictors for the current block using TIMD techniques, where the predictors are combined together by means of blending, where sample-based blending is used.

According to an embodiment usage of sample-based blending on TIMD parameters is inferred.

According to an embodiment a number of templates are considered, where a predictor is obtained for a template using intra-prediction, where a distortion is computed between a predictor and a template, and where the distortion is used to infer usage of sample-based blending.

According to an embodiment a flag is read from a bitstream indicating usage of sample-based blending.

According to an embodiment a sample-based blending is performed, where weights used for blending depend on the location of each sample within the block, and/or on the distortion, and/or on the location of a template with respect to the current block.

A method operating according to some embodiments produces an intra-prediction for a given block, where at least two intra-prediction modes are considered for usage to predict the current block, where the area in the surrounding of the current block is divided in a number of at least two templates, where TIMD parameters are computed for each template depending on the considered intra-prediction modes, and where the parameters are used to form a prediction for the current block.

According to an embodiment a distortion between a predictor and a template is computed, where the predictor is obtained performing intra-prediction using one of the considered intra-prediction modes on a given template, where the distortions obtained for each template are used to determine the type of blending to use to form a final prediction for the current block.

According to an embodiment usage of sample-based blending is inferred based on the distortions.

According to an embodiment the weights for sample-based blending are computed depending on the distortions obtained for each template.

According to an embodiment the weights which will be obtained for a given predictor may also depend on distortions computed for each TIMD mode on a template, and/or on how these distortions compare to each other.

According to an embodiment the Planar mode may be used to derive a predictor e.g. when the current block is at the top of the frame and/or at the left border of the frame.

According to an embodiment selection of the intra-prediction modes for a given template also depends on the intra-prediction mode obtained for one or more other template.

According to an embodiment distortions obtained on a first template and a second template are compared one with the other, wherein the mode for the template with larger distortion is substituted with a different mode. A method operating according to some embodiments produces an intra-prediction for a given block, where at least two intra-prediction modes are considered for usage to predict the current block, where the area in the surrounding of the current block is divided in a number of at least two templates, where a search among a number of candidate intra-prediction modes is performed for each template resulting in a list of selected TIMD modes for each template, and where the list of TIMD modes for each template is used to determine the type of blending to use to form a final prediction for the current block using the considered intra-prediction modes.

An apparatus according to a first aspect comprises at least one processor and at least one memory storing instructions that, when executed by the at least one processor, cause the apparatus at least to:
decode encoded video data to obtain reconstructed samples of a picture;
use the reconstructed samples to intra-predict a current block of the picture;
divide an area in a surrounding of the current block into at least two templates formed of the already reconstructed samples at specific locations with respect to the current block;
determine for each template one or more intra-prediction modes by template-based intra mode derivation;
compute at least two predictors of the current block based on the determined intra-prediction modes; and
combine the at least two predictors together using blending by sample-based weights to form a prediction block for the current block.

A method according to a second aspect comprises:
decoding encoded video data to obtain reconstructed samples of a picture;
using the reconstructed samples to intra-predict a current block of the picture;
dividing an area in a surrounding of the current block into at least two templates formed of the already reconstructed samples at specific locations with respect to the current block;
determining for each template one or more intra-prediction modes by template-based intra mode derivation;
computing at least two predictors of the current block based on the determined intra-prediction modes; and
combining the at least two predictors together using blending by sample-based weights to form a prediction block for the current block.

An apparatus according to a third aspect comprises:
means for decoding encoded video data to obtain reconstructed samples of a picture;
means for using the reconstructed samples to intra-predict a current block of the picture;
means for dividing an area in a surrounding of the current block into at least two templates formed of the already reconstructed samples at specific locations with respect to the current block;
means for determining for each template one or more intra-prediction modes by template-based intra mode derivation;
means for computing at least two predictors of the current block based on the determined intra-prediction modes; and
means for combining the at least two predictors together using blending to form a prediction block for the current block, wherein the means for combining are configured to use sample-based weights.

A computer readable storage medium according to a fourth aspect comprises code for use by an apparatus, which when executed by a processor, causes the apparatus to:
decode encoded video data to obtain reconstructed samples of a picture;
use the reconstructed samples to intra-predict a current block of the picture;
divide an area in a surrounding of the current block into at least two templates formed of the already reconstructed samples at specific locations with respect to the current block;
determine for each template one or more intra-prediction modes by template-based intra mode derivation;
compute at least two predictors of the current block based on the determined intra-prediction modes; and
combine the at least two predictors together using blending by sample-based weights to form a prediction block for the current block.

An encoder according to a fifth aspect comprises:
means for decoding encoded video data to obtain reconstructed samples of a picture;
means for using the reconstructed samples to intra-predict a current block of the picture;
means for dividing an area in a surrounding of the current block into at least two templates formed of the already reconstructed samples at specific locations with respect to the current block;
means for determining for each template one or more intra-prediction modes by template-based intra mode derivation;
means for computing at least two predictors of the current block based on the determined intra-prediction modes; and
means for combining the at least two predictors together using blending to form a prediction block for the current block, wherein the means for combining are configured to use sample-based weights.

A decoder according to a sixth aspect comprises:
means for decoding encoded video data to obtain reconstructed samples of a picture;
means for using the reconstructed samples to intra-predict a current block of the picture;
means for dividing an area in a surrounding of the current block into at least two templates formed of the already reconstructed samples at specific locations with respect to the current block;
means for determining for each template one or more intra-prediction modes by template-based intra mode derivation;
means for computing at least two predictors of the current block based on the determined intra-prediction modes; and
means for combining the at least two predictors together using blending to form a prediction block for the current block, wherein the means for combining are configured to use sample-based weights.

The apparatuses and the computer readable storage mediums stored with code thereon, as described above, are thus arranged to carry out the above methods and one or more of the embodiments related thereto.

### BRIEF DESCRIPTION OF THE DRAWINGS

For better understanding of the present invention, reference will now be made by way of example to the accompanying drawings in which:

FIG. 1 shows schematically an electronic device employing embodiments;

FIG. 2 shows schematically a user equipment suitable for employing embodiments;

FIG. 3 further shows schematically electronic devices employing embodiments connected using wireless and wired network connections;

FIG. 4 shows schematically an encoder suitable for implementing embodiments;

FIG. 5 illustrates an example of an encoder and decoder structure that can be used to encode and decode video and images using template-based intra prediction derivation, in accordance with an embodiment;

FIGS. 6a to 6c illustrate a template-based intra prediction derivation techniques using two templates, according to an embodiment;

FIG. 6d illustrates some intra-prediction modes;

FIG. 6e illustrates a template-based intra prediction derivation techniques using a master template and two additional templates, according to an embodiment;

FIG. 7 shows a flow chart of a coding method according to an embodiment;

FIG. 8 shows a schematic diagram of a decoder suitable for implementing embodiments; and

FIG. 9 shows a schematic diagram of an example multimedia communication system within which various embodiments may be implemented.

### DETAILED DESCRIPTION OF SOME EXAMPLE EMBODIMENTS

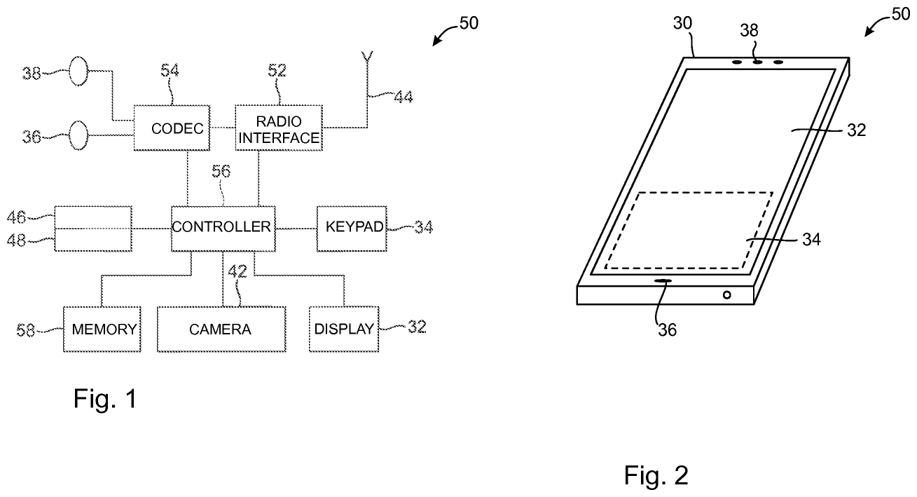

The following describes in further detail suitable apparatus and possible mechanisms for dual transformation and an inverse dual transformation. In this regard reference is first made to FIGS. 1 and 2, where FIG. 1 shows a block diagram of a video coding system according to an example embodiment as a schematic block diagram of an exemplary apparatus or electronic device 50, which may incorporate a codec according to an embodiment. FIG. 2 shows a layout of an apparatus according to an example embodiment. The elements of FIGS. 1 and 2 will be explained next.

The electronic device 50 may for example be a mobile terminal or user equipment of a wireless communication system. However, it would be appreciated that embodiments may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments the display may be any suitable display technology suitable to display an image or video. The apparatus 50 may further comprise a keypad 34. In other embodiments any suitable data or user interface mechanism may be employed. For example the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device which in embodiments may be any one of: an earpiece 38, speaker, or an analogue audio or digital audio output connection. The apparatus 50 may also comprise a battery (or in other embodiments the device may be powered by any suitable mobile energy device such as solar cell, fuel cell or clockwork generator). The apparatus may further comprise a camera capable of recording or capturing images and/or video. The apparatus 50 may further comprise an infrared port for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56, processor or processor circuitry for controlling the apparatus 50. The controller 56 may be connected to memory 58 which in embodiments may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

The apparatus 50 may comprise a camera capable of recording or detecting individual frames which are then passed to the codec 54 or the controller for processing. The apparatus may receive the video image data for processing from another device prior to transmission and/or storage. The apparatus 50 may also receive either wirelessly or by a wired connection the image for coding/decoding. The structural elements of apparatus 50 described above represent examples of means for performing a corresponding function.

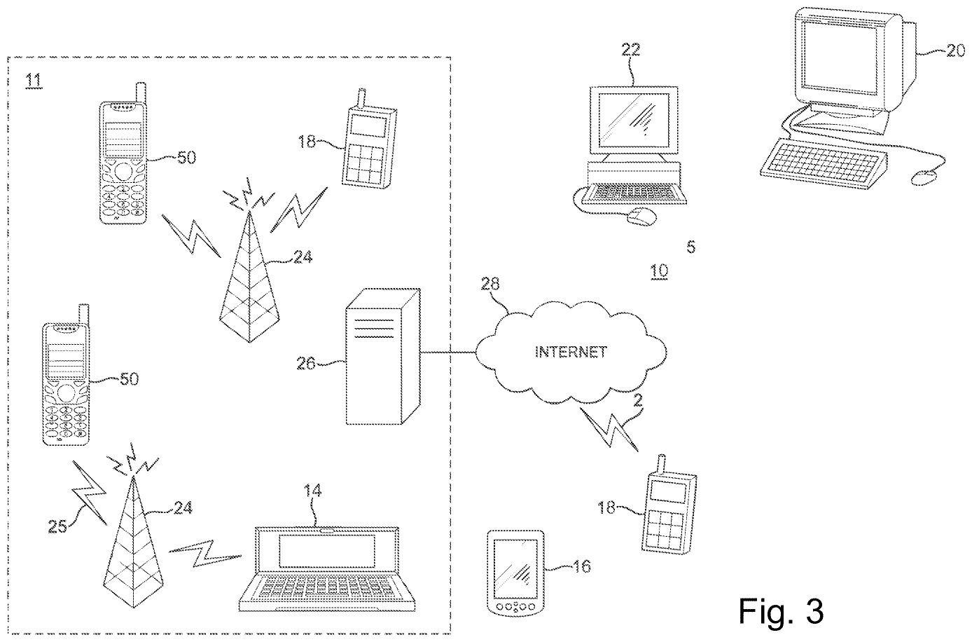

With respect to FIG. 3, an example of a system within which embodiments of the present invention can be utilized is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc.), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices and/or apparatus 50 suitable for implementing embodiments.

For example, the system shown in FIG. 3 shows a mobile telephone network 11 and a representation of the internet 28. Connectivity to the internet 28 may include, but is not limited to, long range wireless connections, short range wireless connections, and various wired connections including, but not limited to, telephone lines, cable lines, power lines, and similar communication pathways.

The example communication devices shown in the system 10 may include, but are not limited to, an electronic device or apparatus 50, a combination of a personal digital assistant (PDA) and a mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; i.e. a digital TV receiver, which may/may not have a display or wireless capabilities, in tablets or (laptop) personal computers (PC), which have hardware or software or combination of the encoder/decoder implementations, in various operating systems, and in chipsets, processors, DSPs and/or embedded systems offering hardware/software based coding.

Some or further apparatus may send and receive calls and messages and communicate with service providers through a wireless connection 25 to a base station 24. The base station 24 may be connected to a network server 26 that allows communication between the mobile telephone network 11 and the internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involved in implementing various embodiments of the present invention may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

An MPEG-2 transport stream (TS), specified in ISO/IEC 13818-1 or equivalently in ITU-T Recommendation H.222.0, is a format for carrying audio, video, and other media as well as program metadata or other metadata, in a multiplexed stream. A packet identifier (PID) is used to identify an elementary stream (a.k.a. packetized elementary stream) within the TS. Hence, a logical channel within an MPEG-2 TS may be considered to correspond to a specific PID value.

Available media file format standards include ISO base media file format (ISO/IEC 14496-12, which may be abbreviated ISOBMFF) and file format for NAL unit structured video (ISO/IEC 14496-15), which derives from the ISOBMFF.

Video codec consists of an encoder that transforms the input video into a compressed representation suited for storage/transmission and a decoder that can uncompress the compressed video representation back into a viewable form. A video encoder and/or a video decoder may also be separate from each other, i.e. need not form a codec. Typically encoder discards some information in the original video sequence in order to represent the video in a more compact form (that is, at lower bitrate).

Typical hybrid video encoders, for example many encoder implementations of ITU-T H.263 and H.264, encode the video information in two phases. Firstly pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e. the difference between the predicted block of pixels and the original block of pixels, is coded. This is typically done by transforming the difference in pixel values using a specified transform (e.g. Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

In temporal prediction, the sources of prediction are previously decoded pictures (a.k.a. reference pictures). In intra block copy (IBC; a.k.a. intra-block-copy prediction), prediction is applied similarly to temporal prediction but the reference picture is the current picture and only previously decoded samples can be referred in the prediction process. Inter-layer or inter-view prediction may be applied similarly to temporal prediction, but the reference picture is a decoded picture from another scalable layer or from another view, respectively. In some cases, inter prediction may refer to temporal prediction only, while in other cases inter prediction may refer collectively to temporal prediction and any of intra block copy, inter-layer prediction, and inter-view prediction provided that they are performed with the same or similar process than temporal prediction. Inter prediction or temporal prediction may sometimes be referred to as motion compensation or motion-compensated prediction.

Motion compensation can be performed either with full sample or sub-sample accuracy. In the case of full sample accurate motion compensation, motion can be represented as a motion vector with integer values for horizontal and vertical displacement and the motion compensation process effectively copies samples from the reference picture using those displacements. In the case of sub-sample accurate motion compensation, motion vectors are represented by fractional or decimal values for the horizontal and vertical components of the motion vector. In the case a motion vector is referring to a non-integer position in the reference picture, a sub-sample interpolation process is typically invoked to calculate predicted sample values based on the reference samples and the selected sub-sample position. The sub-sample interpolation process typically consists of horizontal filtering compensating for horizontal offsets with respect to full sample positions followed by vertical filtering compensating for vertical offsets with respect to full sample positions. However, the vertical processing can be also be done before horizontal processing in some environments.

Inter prediction, which may also be referred to as temporal prediction, motion compensation, or motion-compensated prediction, reduces temporal redundancy. In inter prediction the sources of prediction are previously decoded pictures. Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

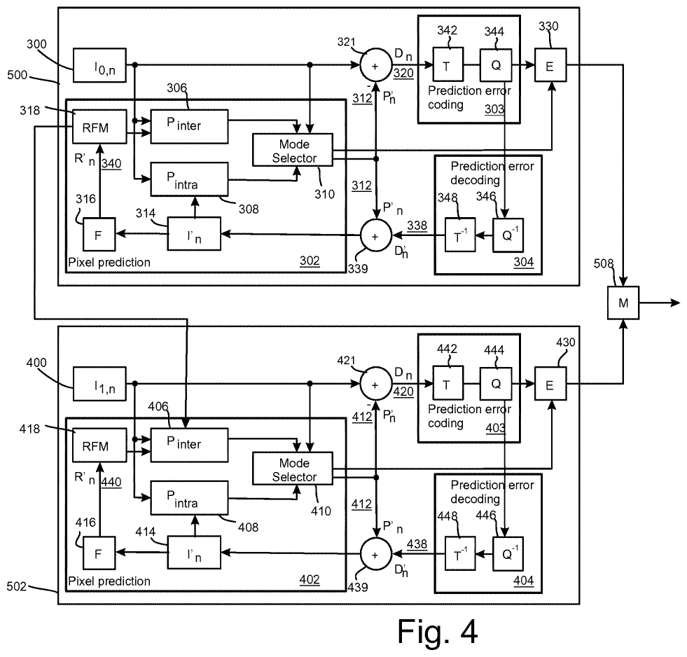

FIG. 4 shows a block diagram of a video encoder suitable for employing embodiments. FIG. 4 presents an encoder for two layers, but it would be appreciated that presented encoder could be similarly extended to encode more than two layers. FIG. 4 illustrates an embodiment of a video encoder comprising a first encoder section 500 for a base layer and a second encoder section 502 for an enhancement layer. Each of the first encoder section 500 and the second encoder section 502 may comprise similar elements for encoding incoming pictures. The encoder sections 500, 502 may comprise a pixel predictor 302, 402, prediction error encoder 303, 403 and prediction error decoder 304, 404. FIG. 4 also shows an embodiment of the pixel predictor 302, 402 as comprising an inter-predictor 306, 406, an intra-predictor 308, 408, a mode selector 310, 410, a filter 316, 416, and a reference frame memory 318, 418. The pixel predictor 302 of the first encoder section 500 receives 300 base layer images of a video stream to be encoded at both the inter-predictor 306 (which determines the difference between the image and a motion compensated reference frame 318) and the intra-predictor 308 (which determines a prediction for an image block based only on the already processed parts of current frame or picture). The output of both the inter-predictor and the intra-predictor are passed to the mode selector 310. The intra-predictor 308 may have more than one intra-prediction modes. Hence, each mode may perform the intra-prediction and provide the predicted signal to the mode selector 310. The mode selector 310 also receives a copy of the base layer picture 300. Correspondingly, the pixel predictor 402 of the second encoder section 502 receives 400 enhancement layer images of a video stream to be encoded at both the inter-predictor 406 (which determines the difference between the image and a motion compensated reference frame 418) and the intra-predictor 408 (which determines a prediction for an image block based only on the already processed parts of current frame or picture). The output of both the inter-predictor and the intra-predictor are passed to the mode selector 410. The intra-predictor 408 may have more than one intra-prediction modes. Hence, each mode may perform the intra-prediction and provide the predicted signal to the mode selector 410. The mode selector 410 also receives a copy of the enhancement layer picture 400.

Depending on which encoding mode is selected to encode the current block, the output of the inter-predictor 306, 406 or the output of one of the optional intra-predictor modes or the output of a surface encoder within the mode selector is passed to the output of the mode selector 310, 410. The output of the mode selector is passed to a first summing device 321, 421. The first summing device may subtract the output of the pixel predictor 302, 402 from the base layer picture 300/enhancement layer picture 400 to produce a first prediction error signal 320, 420 which is input to the prediction error encoder 303, 403.

The pixel predictor 302, 402 further receives from a preliminary reconstructor 339, 439 the combination of the prediction representation of the image block 312, 412 and the output 338, 438 of the prediction error decoder 304, 404. The preliminary reconstructed image 314, 414 may be passed to the intra-predictor 308, 408 and to a filter 316, 416. The filter 316, 416 receiving the preliminary representation may filter the preliminary representation and output a final reconstructed image 340, 440 which may be saved in a reference frame memory 318, 418. The reference frame memory 318 may be connected to the inter-predictor 306 to be used as the reference image against which a future base layer picture 300 is compared in inter-prediction operations. Subject to the base layer being selected and indicated to be source for inter-layer sample prediction and/or inter-layer motion information prediction of the enhancement layer according to some embodiments, the reference frame memory 318 may also be connected to the inter-predictor 406 to be used as the reference image against which a future enhancement layer pictures 400 is compared in inter-prediction operations. Moreover, the reference frame memory 418 may be connected to the inter-predictor 406 to be used as the reference image against which a future enhancement layer picture 400 is compared in inter-prediction operations.

Filtering parameters from the filter 316 of the first encoder section 500 may be provided to the second encoder section 502 subject to the base layer being selected and indicated to be source for predicting the filtering parameters of the enhancement layer according to some embodiments.

The prediction error encoder 303, 403 comprises a transform unit 342, 442 and a quantizer 344, 444. The transform unit 342, 442 transforms the first prediction error signal 320, 420 to a transform domain. The transform is, for example, the DCT transform. The quantizer 344, 444 quantizes the transform domain signal, e.g. the DCT coefficients, to form quantized coefficients.

The prediction error decoder 304, 404 receives the output from the prediction error encoder 303, 403 and performs the opposite processes of the prediction error encoder 303, 403 to produce a decoded prediction error signal 338, 438 which, when combined with the prediction representation of the image block 312, 412 at the second summing device 339, 439, produces the preliminary reconstructed image 314, 414. The prediction error decoder may be considered to comprise a dequantizer 361, 461, which dequantizes the quantized coefficient values, e.g. DCT coefficients, to reconstruct the transform signal and an inverse transformation unit 363, 463, which performs the inverse transformation to the reconstructed transform signal wherein the output of the inverse transformation unit 363, 463 contains reconstructed block(s). The prediction error decoder may also comprise a block filter which may filter the reconstructed block(s) according to further decoded information and filter parameters.

The entropy encoder 330, 430 receives the output of the prediction error encoder 303, 403 and may perform a suitable entropy encoding/variable length encoding on the signal to provide error detection and correction capability. The outputs of the entropy encoders 330, 430 may be inserted into a bitstream e.g. by a multiplexer 508.

Entropy coding/decoding may be performed in many ways. For example, context-based coding/decoding may be applied, where in both the encoder and the decoder modify the context state of a coding parameter based on previously coded/decoded coding parameters. Context-based coding may for example be context adaptive binary arithmetic coding (CABAC) or context-based variable length coding (CAVLC) or any similar entropy coding. Entropy coding/decoding may alternatively or additionally be performed using a variable length coding scheme, such as Huffman coding/decoding or Exp-Golomb coding/decoding. Decoding of coding parameters from an entropy-coded bitstream or codewords may be referred to as parsing.

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organisation for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). There have been multiple versions of the H.264/AVC standard, integrating new extensions or features to the specification. These extensions include Scalable Video Coding (SVC) and Multiview Video Coding (MVC).

Version 1 of the High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

SHVC, MV-HEVC, and 3D-HEVC use a common basis specification, specified in Annex F of the version 2 of the HEVC standard. This common basis comprises for example high-level syntax and semantics e.g. specifying some of the characteristics of the layers of the bitstream, such as inter-layer dependencies, as well as decoding processes, such as reference picture list construction including inter-layer reference pictures and picture order count derivation for multi-layer bitstream. Annex F may also be used in potential subsequent multi-layer extensions of HEVC. It is to be understood that even though a video encoder, a video decoder, encoding methods, decoding methods, bitstream structures, and/or embodiments may be described in the following with reference to specific extensions, such as SHVC and/or MV-HEVC, they are generally applicable to any multi-layer extensions of HEVC, and even more generally to any multi-layer video coding scheme.

Versatile Video Coding (VVC) (MPEG-I Part 3), a.k.a. ITU-T H.266, is a video compression standard being developed by the Joint Video Experts Team (JVET) of the Moving Picture Experts Group (MPEG), (formally ISO/IEC JTC1 SC29 WG11) and Video Coding Experts Group (VCEG) of the International Telecommunication Union (ITU) to be the successor to HEVC/H.265.

Some key definitions, bitstream and coding structures, and concepts of H.264/AVC and HEVC are described in this section as an example of a video encoder, decoder, encoding method, decoding method, and a bitstream structure, wherein the embodiments may be implemented. Some of the key definitions, bitstream and coding structures, and concepts of H.264/AVC are the same as in HEVC-hence, they are described below jointly. The aspects of the invention are not limited to H.264/AVC or HEVC, but rather the description is given for one possible basis on top of which the invention may be partly or fully realized.

Similarly to many earlier video coding standards, the bitstream syntax and semantics as well as the decoding process for error-free bitstreams are specified in H.264/AVC and HEVC. The encoding process is not specified, but encoders must generate conforming bitstreams. Bitstream and decoder conformance can be verified with the Hypothetical Reference Decoder (HRD). The standards contain coding tools that help in coping with transmission errors and losses, but the use of the tools in encoding is optional and no decoding process has been specified for erroneous bitstreams.

The elementary unit for the input to an H.264/AVC or HEVC encoder and the output of an H.264/AVC or HEVC decoder, respectively, is a picture. A picture given as an input to an encoder may also be referred to as a source picture, and a picture decoded by a decoded may be referred to as a decoded picture.

The source and decoded pictures are each comprised of one or more sample arrays, such as one of the following sets of sample arrays:
Luma (Y) only (monochrome).
Luma and two chroma (YCbCr or YCgCo).
Green, Blue and Red (GBR, also known as RGB).
Arrays representing other unspecified monochrome or tri-stimulus color samplings (for example, YZX, also known as XYZ).

In H.264/AVC and HEVC, a picture may either be a frame or a field. A frame comprises a matrix of luma samples and possibly the corresponding chroma samples. A field is a set of alternate sample rows of a frame and may be used as encoder input, when the source signal is interlaced. Chroma sample arrays may be absent (and hence monochrome sampling may be in use) or chroma sample arrays may be subsampled when compared to luma sample arrays. Chroma formats may be summarized as follows:
In monochrome sampling there is only one sample array, which may be nominally considered the luma array.
In 4:2:0 sampling, each of the two chroma arrays has half the height and half the width of the luma array.
In 4:2:2 sampling, each of the two chroma arrays has the same height and half the width of the luma array.
In 4:4:4 sampling when no separate color planes are in use, each of the two chroma arrays has the same height and width as the luma array.

In H.264/AVC and HEVC, it is possible to code sample arrays as separate color planes into the bitstream and respectively decode separately coded color planes from the bitstream. When separate color planes are in use, each one of them is separately processed (by the encoder and/or the decoder) as a picture with monochrome sampling.

A partitioning may be defined as a division of a set into subsets such that each element of the set is in exactly one of the subsets.

When describing the operation of HEVC encoding and/or decoding, the following terms may be used. A coding block may be defined as an N×N block of samples for some value of N such that the division of a coding tree block into coding blocks is a partitioning. A coding tree block (CTB) may be defined as an N×N block of samples for some value of N such that the division of a component into coding tree blocks is a partitioning. A coding tree unit (CTU) may be defined as a coding tree block of luma samples, two corresponding coding tree blocks of chroma samples of a picture that has three sample arrays, or a coding tree block of samples of a monochrome picture or a picture that is coded using three separate color planes and syntax structures used to code the samples.

In some video codecs, such as H.265/HEVC, video pictures are divided into coding units (CU) covering the area of the picture. A coding unit (CU) may be defined as a coding block of luma samples, two corresponding coding blocks of chroma samples of a picture that has three sample arrays, or a coding block of samples of a monochrome picture or a picture that is coded using three separate color planes and syntax structures used to code the samples. A CU with the maximum allowed size may be named as LCU (largest coding unit) or coding tree unit (CTU) and the video picture is divided into non-overlapping LCUs.

A CU consists of one or more prediction units (PU) defining the prediction process for the samples within the CU and one or more transform units (TU) defining the prediction error coding process for the samples in the said CU. Typically, a CU consists of a square block of samples with a size selectable from a predefined set of possible CU sizes. Each PU and TU can further be split into smaller PUs and TUs in order to increase granularity of the prediction and prediction error coding processes, respectively. Each PU has prediction information associated with it defining what kind of a prediction is to be applied for the pixels within that PU (e.g. motion vector information for inter predicted PUs and intra prediction directionality information for intra predicted PUs).

Each TU can be associated with information describing the prediction error decoding process for the samples within the said TU (including e.g. DCT coefficient information). It is typically signalled at CU level whether prediction error coding is applied or not for each CU. In the case there is no prediction error residual associated with the CU, it can be considered there are no TUs for the said CU. The division of the image into CUs, and division of CUs into PUs and TUs is typically signalled in the bitstream allowing the decoder to reproduce the intended structure of these units.

In HEVC, a picture can be partitioned in tiles, which are rectangular and contain an integer number of LCUs. In HEVC, the partitioning to tiles forms a regular grid, where heights and widths of tiles differ from each other by one LCU at the maximum. In HEVC, a slice is defined to be an integer number of coding tree units contained in one independent slice segment and all subsequent dependent slice segments (if any) that precede the next independent slice segment (if any) within the same access unit. In HEVC, a slice segment is defined to be an integer number of coding tree units ordered consecutively in the tile scan and contained in a single NAL unit. The division of each picture into slice segments is a partitioning. In HEVC, an independent slice segment is defined to be a slice segment for which the values of the syntax elements of the slice segment header are not inferred from the values for a preceding slice segment, and a dependent slice segment is defined to be a slice segment for which the values of some syntax elements of the slice segment header are inferred from the values for the preceding independent slice segment in decoding order. In HEVC, a slice header is defined to be the slice segment header of the independent slice segment that is a current slice segment or is the independent slice segment that precedes a current dependent slice segment, and a slice segment header is defined to be a part of a coded slice segment containing the data elements pertaining to the first or all coding tree units represented in the slice segment. The CUs are scanned in the raster scan order of LCUs within tiles or within a picture, if tiles are not in use. Within an LCU, the CUs have a specific scan order.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

The filtering may for example include one more of the following: deblocking, sample adaptive offset (SAO), and/or adaptive loop filtering (ALF). H.264/AVC includes a deblocking, whereas HEVC includes both deblocking and SAO.

Instead of or in addition to approaches utilizing sample value prediction and transform coding for indicating the coded sample values, a color palette based coding may be used. Palette based coding refers to a family of approaches for which a palette, i.e. a set of colors and associated indexes, is defined and the value for each sample within a coding unit is expressed by indicating its index in the palette. Palette based coding may achieve good coding efficiency in coding units with a relatively small number of colors (such as image areas which are representing computer screen content, like text or simple graphics). In order to improve the coding efficiency of palette coding different kinds of palette index prediction approaches may be utilized, or the palette indexes can be run-length coded to be able to represent larger homogenous image areas efficiently. Also, in the case the CU contains sample values that are not recurring within the CU, escape coding can be utilized. Escape coded samples are transmitted without referring to any of the palette indexes. Instead their values are indicated individually for each escape coded sample.

In typical video codecs the motion information is indicated with motion vectors associated with each motion compensated image block, such as a prediction unit. Each of these motion vectors represents the displacement of the image block in the picture to be coded (in the encoder side) or decoded (in the decoder side) and the prediction source block in one of the previously coded or decoded pictures. In order to represent motion vectors efficiently those are typically coded differentially with respect to block specific predicted motion vectors. In typical video codecs the predicted motion vectors are created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signalling the chosen candidate as the motion vector predictor. In addition to predicting the motion vector values, it can be predicted which reference picture(s) are used for motion-compensated prediction and this prediction information may be represented for example by a reference index of previously coded/decoded picture. The reference index is typically predicted from adjacent blocks and/or co-located blocks in temporal reference picture. Moreover, typical high efficiency video codecs employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information is carried out using the motion field information of adjacent blocks and/or co-located blocks in temporal reference pictures and the used motion field information is signalled among a list of motion field candidate list filled with motion field information of available adjacent/co-located blocks.

Typically video codecs support motion compensated prediction from one source image (uni-prediction) and two sources (bi-prediction). In the case of uni-prediction a single motion vector is applied whereas in the case of bi-prediction two motion vectors are signaled and the motion compensated predictions from two sources are averaged to create the final sample prediction. In the case of weighted prediction the relative weights of the two predictions can be adjusted, or a signaled offset can be added to the prediction signal.

In addition to applying motion compensation for inter picture prediction, similar approach can be applied to intra picture prediction. In this case the displacement vector indicates where from the same picture a block of samples can be copied to form a prediction of the block to be coded or decoded. This kind of intra block copying methods can improve the coding efficiency substantially in presence of repeating structures within the frame-such as text or other graphics.

In typical video codecs the prediction residual after motion compensation is first transformed with a transform kernel (like DCT) and then coded. The reason for this is that often there still exists some correlation among the residual and transform can in many cases help reduce this correlation and provide more efficient coding.

Typical video encoders utilize Lagrangian cost functions to find optimal coding modes, e.g. the desired coding mode for a block and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R , \qquad ( 1 )$$

where C is the Lagrangian cost to be minimized, D is the image distortion (e.g. Mean Squared Error) with the mode and motion vectors considered, and R the number of bits needed to represent the required data to reconstruct the image block in the decoder (including the amount of data to represent the candidate motion vectors).

Video coding standards and specifications may allow encoders to divide a coded picture to into independently codable and decodable image segments such as slices, tiles or alike. Slices typically refer to image segments constructed of certain number of basic coding units that are processed in default coding or decoding order, while tiles typically refer to image segments that have been defined as rectangular image regions that are processed at least to some extend as individual frames.

In-picture prediction is typically disabled across slice boundaries. Thus, slices can be regarded as a way to split a coded picture to independently decodable pieces. In H.264/AVC and HEVC, in-picture prediction may be disabled across slice boundaries. Thus, slices can be regarded as a way to split a coded picture into independently decodable pieces, and slices are therefore often regarded as elementary units for transmission. In many cases, encoders may indicate in the bitstream which types of in-picture prediction are turned off across slice boundaries, and the decoder operation takes this information into account for example when concluding which prediction sources are available. For example, samples from a neighboring CU may be regarded as unavailable for intra prediction, if the neighboring CU resides in a different slice.

An elementary unit for the output of an H.264/AVC or HEVC encoder and the input of an H.264/AVC or HEVC decoder, respectively, is a Network Abstraction Layer (NAL) unit. For transport over packet-oriented networks or storage into structured files, NAL units may be encapsulated into packets or similar structures. A bytestream format has been specified in H.264/AVC and HEVC for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

NAL units consist of a header and payload. In H.264/AVC and HEVC, the NAL unit header indicates the type of the NAL unit

In HEVC, a two-byte NAL unit header is used for all specified NAL unit types. The NAL unit header contains one reserved bit, a six-bit NAL unit type indication, a three-bit nuh_temporal_id_plus1 indication for temporal level (may be required to be greater than or equal to 1) and a six-bit nuh_layer_id syntax element. The temporal_id_plus1 syntax element may be regarded as a temporal identifier for the NAL unit, and a zero-based TemporalId variable may be derived as follows: TemporalId=temporal_id_plus1-1. The abbreviation TID may be used to interchangeably with the TemporalId variable. TemporalId equal to 0 corresponds to the lowest temporal level. The value of temporal_id_plus1 is required to be non-zero in order to avoid start code emulation involving the two NAL unit header bytes. The bitstream created by excluding all VCL NAL units having a TemporalId greater than or equal to a selected value and including all other VCL NAL units remains conforming. Consequently, a picture having TemporalId equal to tid_value does not use any picture having a TemporalId greater than tid_value as inter prediction reference. A sub-layer or a temporal sub-layer may be defined to be a temporal scalable layer (or a temporal layer, TL) of a temporal scalable bitstream, consisting of VCL NAL units with a particular value of the TemporalId variable and the associated non-VCL NAL units. nuh_layer_id can be understood as a scalability layer identifier.

NAL units can be categorized into Video Coding Layer (VCL) NAL units and non-VCL NAL units. VCL NAL units are typically coded slice NAL units. In HEVC, VCL NAL units contain syntax elements representing one or more CU.

A non-VCL NAL unit may be for example one of the following types: a sequence parameter set, a picture parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Parameters that remain unchanged through a coded video sequence may be included in a sequence parameter set. In addition to the parameters that may be needed by the decoding process, the sequence parameter set may optionally contain video usability information (VUI), which includes parameters that may be important for buffering, picture output timing, rendering, and resource reservation. In HEVC a sequence parameter set RBSP includes parameters that can be referred to by one or more picture parameter set RBSPs or one or more SEI NAL units containing a buffering period SEI message. A picture parameter set contains such parameters that are likely to be unchanged in several coded pictures. A picture parameter set RBSP may include parameters that can be referred to by the coded slice NAL units of one or more coded pictures.

In HEVC, a video parameter set (VPS) may be defined as a syntax structure containing syntax elements that apply to zero or more entire coded video sequences as determined by the content of a syntax element found in the SPS referred to by a syntax element found in the PPS referred to by a syntax element found in each slice segment header.

A video parameter set RBSP may include parameters that can be referred to by one or more sequence parameter set RBSPs.

The relationship and hierarchy between video parameter set (VPS), sequence parameter set (SPS), and picture parameter set (PPS) may be described as follows. VPS resides one level above SPS in the parameter set hierarchy and in the context of scalability and/or 3D video. VPS may include parameters that are common for all slices across all (scalability or view) layers in the entire coded video sequence. SPS includes the parameters that are common for all slices in a particular (scalability or view) layer in the entire coded video sequence, and may be shared by multiple (scalability or view) layers. PPS includes the parameters that are common for all slices in a particular layer representation (the representation of one scalability or view layer in one access unit) and are likely to be shared by all slices in multiple layer representations.

VPS may provide information about the dependency relationships of the layers in a bitstream, as well as many other information that are applicable to all slices across all (scalability or view) layers in the entire coded video sequence. VPS may be considered to comprise two parts, the base VPS and a VPS extension, where the VPS extension may be optionally present.

Out-of-band transmission, signaling or storage can additionally or alternatively be used for other purposes than tolerance against transmission errors, such as case of access or session negotiation. For example, a sample entry of a track in a file conforming to the ISO Base Media File Format may comprise parameter sets, while the coded data in the bitstream is stored elsewhere in the file or in another file. The phrase along the bitstream (e.g. indicating along the bitstream) or along a coded unit of a bitstream (e.g. indicating along a coded tile) may be used in claims and described embodiments to refer to out-of-band transmission, signaling, or storage in a manner that the out-of-band data is associated with the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively.

A SEI NAL unit may contain one or more SEI messages, which are not required for the decoding of output pictures but may assist in related processes, such as picture output timing, rendering, error detection, error concealment, and resource reservation.

A coded picture is a coded representation of a picture.

In HEVC, a coded picture may be defined as a coded representation of a picture containing all coding tree units of the picture. In HEVC, an access unit (AU) may be defined as a set of NAL units that are associated with each other according to a specified classification rule, are consecutive in decoding order, and contain at most one picture with any specific value of nuh_layer_id. In addition to containing the VCL NAL units of the coded picture, an access unit may also contain non-VCL NAL units. Said specified classification rule may for example associate pictures with the same output time or picture output count value into the same access unit.

A bitstream may be defined as a sequence of bits, in the form of a NAL unit stream or a byte stream, that forms the representation of coded pictures and associated data forming one or more coded video sequences. A first bitstream may be followed by a second bitstream in the same logical channel, such as in the same file or in the same connection of a communication protocol. An elementary stream (in the context of video coding) may be defined as a sequence of one or more bitstreams. The end of the first bitstream may be indicated by a specific NAL unit, which may be referred to as the end of bitstream (EOB) NAL unit and which is the last NAL unit of the bitstream. In HEVC and its current draft extensions, the EOB NAL unit is required to have nuh_layer_id equal to 0.

In H.264/AVC, a coded video sequence is defined to be a sequence of consecutive access units in decoding order from an IDR access unit, inclusive, to the next IDR access unit, exclusive, or to the end of the bitstream, whichever appears earlier.

In HEVC, a coded video sequence (CVS) may be defined, for example, as a sequence of access units that consists, in decoding order, of an IRAP access unit with NoRaslOutputFlag equal to 1, followed by zero or more access units that are not IRAP access units with NoRaslOutputFlag equal to 1, including all subsequent access units up to but not including any subsequent access unit that is an IRAP access unit with NoRaslOutputFlag equal to 1. An IRAP access unit may be defined as an access unit in which the base layer picture is an IRAP picture. The value of NoRaslOutputFlag is equal to 1 for each IDR picture, each BLA picture, and each IRAP picture that is the first picture in that particular layer in the bitstream in decoding order, is the first IRAP picture that follows an end of sequence NAL unit having the same value of nuh_layer_id in decoding order. There may be means to provide the value of HandleCraAsBlaFlag to the decoder from an external entity, such as a player or a receiver, which may control the decoder. HandleCraAsBlaFlag may be set to 1 for example by a player that seeks to a new position in a bitstream or tunes into a broadcast and starts decoding and then starts decoding from a CRA picture. When HandleCraAsBlaFlag is equal to 1 for a CRA picture, the CRA picture is handled and decoded as if it were a BLA picture.

In HEVC, a coded video sequence may additionally or alternatively (to the specification above) be specified to end, when a specific NAL unit, which may be referred to as an end of sequence (EOS) NAL unit, appears in the bitstream and has nuh_layer_id equal to 0.

A group of pictures (GOP) and its characteristics may be defined as follows. A GOP can be decoded regardless of whether any previous pictures were decoded. An open GOP is such a group of pictures in which pictures preceding the initial intra picture in output order might not be correctly decodable when the decoding starts from the initial intra picture of the open GOP. In other words, pictures of an open GOP may refer (in inter prediction) to pictures belonging to a previous GOP. An HEVC decoder can recognize an intra picture starting an open GOP, because a specific NAL unit type, CRA NAL unit type, may be used for its coded slices. A closed GOP is such a group of pictures in which all pictures can be correctly decoded when the decoding starts from the initial intra picture of the closed GOP. In other words, no picture in a closed GOP refers to any pictures in previous GOPs. In H.264/AVC and HEVC, a closed GOP may start from an IDR picture. In HEVC a closed GOP may also start from a BLA_W_RADL or a BLA_N_LP picture. An open GOP coding structure is potentially more efficient in the compression compared to a closed GOP coding structure, due to a larger flexibility in selection of reference pictures.

A Decoded Picture Buffer (DPB) may be used in the encoder and/or in the decoder. There are two reasons to buffer decoded pictures, for references in inter prediction and for reordering decoded pictures into output order. As H.264/AVC and HEVC provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

In many coding modes of H.264/AVC and HEVC, the reference picture for inter prediction is indicated with an index to a reference picture list. The index may be coded with variable length coding, which usually causes a smaller index to have a shorter value for the corresponding syntax element. In H.264/AVC and HEVC, two reference picture lists (reference picture list 0 and reference picture list 1) are generated for each bi-predictive (B) slice, and one reference picture list (reference picture list 0) is formed for each inter-coded (P) slice.

Many coding standards, including H.264/AVC and HEVC, may have decoding process to derive a reference picture index to a reference picture list, which may be used to indicate which one of the multiple reference pictures is used for inter prediction for a particular block. A reference picture index may be coded by an encoder into the bitstream is some inter coding modes or it may be derived (by an encoder and a decoder) for example using neighboring blocks in some other inter coding modes.

Motion parameter types or motion information may include but are not limited to one or more of the following types:
an indication of a prediction type (e.g. intra prediction, uni-prediction, bi-prediction) and/or a number of reference pictures;
an indication of a prediction direction, such as inter (a.k.a. temporal) prediction, inter-layer prediction, inter-view prediction, view synthesis prediction (VSP), and inter-component prediction (which may be indicated per reference picture and/or per prediction type and where in some embodiments inter-view and view-synthesis prediction may be jointly considered as one prediction direction) and/or
an indication of a reference picture type, such as a short-term reference picture and/or a long-term reference picture and/or an inter-layer reference picture (which may be indicated e.g. per reference picture)
a reference index to a reference picture list and/or any other identifier of a reference picture (which may be indicated e.g. per reference picture and the type of which may depend on the prediction direction and/or the reference picture type and which may be accompanied by other relevant pieces of information, such as the reference picture list or alike to which reference index applies);
a horizontal motion vector component (which may be indicated e.g. per prediction block or per reference index or alike);
a vertical motion vector component (which may be indicated e.g. per prediction block or per reference index or alike);
one or more parameters, such as picture order count difference and/or a relative camera separation between the picture containing or associated with the motion parameters and its reference picture, which may be used for scaling of the horizontal motion vector component and/or the vertical motion vector component in one or more motion vector prediction processes (where said one or more parameters may be indicated e.g. per each reference picture or each reference index or alike);
coordinates of a block to which the motion parameters and/or motion information applies, e.g. coordinates of the top-left sample of the block in luma sample units;
extents (e.g. a width and a height) of a block to which the motion parameters and/or motion information applies.

Scalable video coding may refer to coding structure where one bitstream can contain multiple representations of the content, for example, at different bitrates, resolutions or frame rates. In these cases the receiver can extract the desired representation depending on its characteristics (e.g. resolution that matches best the display device). Alternatively, a server or a network element can extract the portions of the bitstream to be transmitted to the receiver depending on e.g. the network characteristics or processing capabilities of the receiver. A meaningful decoded representation can be produced by decoding only certain parts of a scalable bit stream. A scalable bitstream typically consists of a “base layer” providing the lowest quality video available and one or more enhancement layers that enhance the video quality when received and decoded together with the lower layers. In order to improve coding efficiency for the enhancement layers, the coded representation of that layer typically depends on the lower layers. E.g. the motion and mode information of the enhancement layer can be predicted from lower layers. Similarly the pixel data of the lower layers can be used to create prediction for the enhancement layer.

In some scalable video coding schemes, a video signal can be encoded into a base layer and one or more enhancement layers. An enhancement layer may enhance, for example, the temporal resolution (i.e., the frame rate), the spatial resolution, or simply the quality of the video content represented by another layer or part thereof. Each layer together with all its dependent layers is one representation of the video signal, for example, at a certain spatial resolution, temporal resolution and quality level. In this document, we refer to a scalable layer together with all of its dependent layers as a “scalable layer representation”. The portion of a scalable bitstream corresponding to a scalable layer representation can be extracted and decoded to produce a representation of the original signal at certain fidelity.

Scalability modes or scalability dimensions may include but are not limited to the following:
Quality scalability: Base layer pictures are coded at a lower quality than enhancement layer pictures, which may be achieved for example using a greater quantization parameter value (i.e., a greater quantization step size for transform coefficient quantization) in the base layer than in the enhancement layer. Quality scalability may be further categorized into fine-grain or fine-granularity scalability (FGS), medium-grain or medium-granularity scalability (MGS), and/or coarse-grain or coarse-granularity scalability (CGS), as described below.
Spatial scalability: Base layer pictures are coded at a lower resolution (i.e. have fewer samples) than enhancement layer pictures. Spatial scalability and quality scalability, particularly its coarse-grain scalability type, may sometimes be considered the same type of scalability.
Bit-depth scalability: Base layer pictures are coded at lower bit-depth (e.g. 8 bits) than enhancement layer pictures (e.g. 10 or 12 bits).
Dynamic range scalability: Scalable layers represent a different dynamic range and/or images obtained using a different tone mapping function and/or a different optical transfer function.
Chroma format scalability: Base layer pictures provide lower spatial resolution in chroma sample arrays (e.g. coded in 4:2:0 chroma format) than enhancement layer pictures (e.g. 4:4:4 format).
Color gamut scalability: enhancement layer pictures have a richer/broader color representation range than that of the base layer pictures—for example the enhancement layer may have UHDTV (ITU-R BT.2020) color gamut and the base layer may have the ITU-R BT.709 color gamut.
View scalability, which may also be referred to as multiview coding. The base layer represents a first view, whereas an enhancement layer represents a second view. A view may be defined as a sequence of pictures representing one camera or viewpoint. It may be considered that in stereoscopic or two-view video, one video sequence or view is presented for the left eye while a parallel view is presented for the right eye.
Depth scalability, which may also be referred to as depth-enhanced coding. A layer or some layers of a bitstream may represent texture view(s), while other layer or layers may represent depth view(s).
Region-of-interest scalability (as described below).
Interlaced-to-progressive scalability (also known as field-to-frame scalability): coded interlaced source content material of the base layer is enhanced with an enhancement layer to represent progressive source content. The coded interlaced source content in the base layer may comprise coded fields, coded frames representing field pairs, or a mixture of them. In the interlace-to-progressive scalability, the base-layer picture may be resampled so that it becomes a suitable reference picture for one or more enhancement-layer pictures.
Hybrid codec scalability (also known as coding standard scalability): In hybrid codec scalability, the bitstream syntax, semantics and decoding process of the base layer and the enhancement layer are specified in different video coding standards. Thus, base layer pictures are coded according to a different coding standard or format than enhancement layer pictures. For example, the base layer may be coded with H.264/AVC and an enhancement layer may be coded with an HEVC multi-layer extension.

For example in the above mentioned spatial, bit-depth and chroma format scalability cases, base layer information could be used to code enhancement layer to minimize the additional bitrate overhead.

Scalability can be enabled at least in two basic ways: by introducing new coding modes for performing prediction of pixel values or syntax from lower layers of the scalable representation or by placing the lower layer pictures to the reference picture buffer (decoded picture buffer, DPB) of the higher layer. The first approach may be more flexible and thus can provide better coding efficiency in most cases. However, the second, reference frame based scalability, approach may be implemented very efficiently with minimal changes to single layer codecs while still achieving majority of the coding efficiency gains available. In accordance with an approach, a reference frame based scalability codec can be implemented by utilizing the same hardware or software implementation for all the layers, just taking care of the DPB management by external means.

In order to be able to utilize parallel processing, images can be split into independently codable and decodable image segments (slices or tiles). Slices typically refer to image segments constructed of certain number of basic coding units that are processed in default coding or decoding order, while tiles typically refer to image segments that have been defined as rectangular image regions that are processed at least to some extend as individual frames.

It should be understood that many of the scalability types may be combined and applied together. For example color gamut scalability and bit-depth scalability may be combined.

The term layer may be used in context of any type of scalability, including view scalability and depth enhancements. An enhancement layer may refer to any type of an enhancement, such as SNR, spatial, multiview, depth, bit-depth, chroma format, and/or color gamut enhancement. A base layer may refer to any type of a base video sequence, such as a base view, a base layer for SNR/spatial scalability, or a texture base view for depth-enhanced video coding.

As described above, still pictures and pictures in a video sequence are typically split into smaller blocks of samples, which are predicted either by spatial or temporal means and remaining error between the prediction block and the corresponding block in the original image is coded with residual coding means. Residual coding means typically include transforming a residual block into frequency domain (using e.g. DCT (Discrete Cosine Transform) or its derivatives as the primary transform), quantization of the resulting transform coefficients and entropy coding the quantized coefficients.

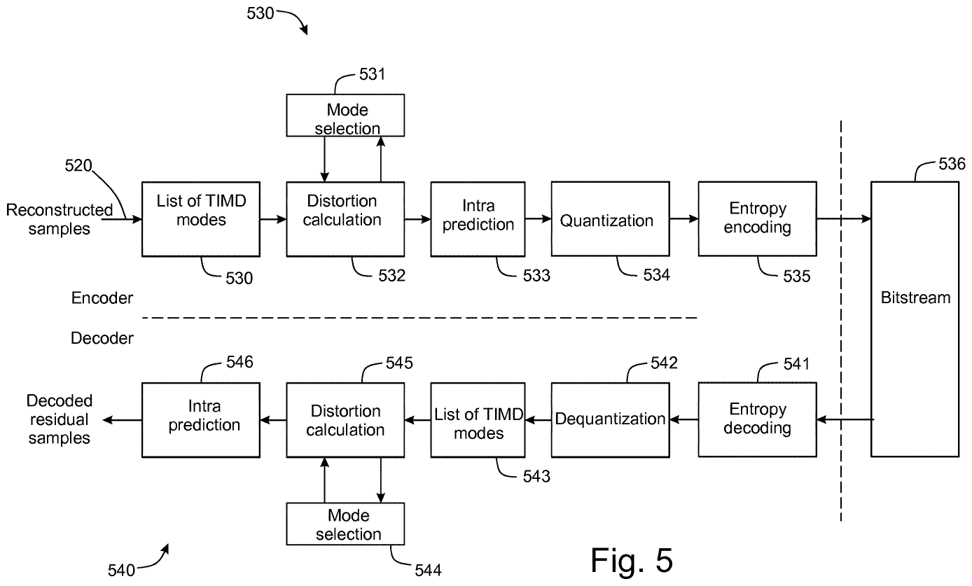

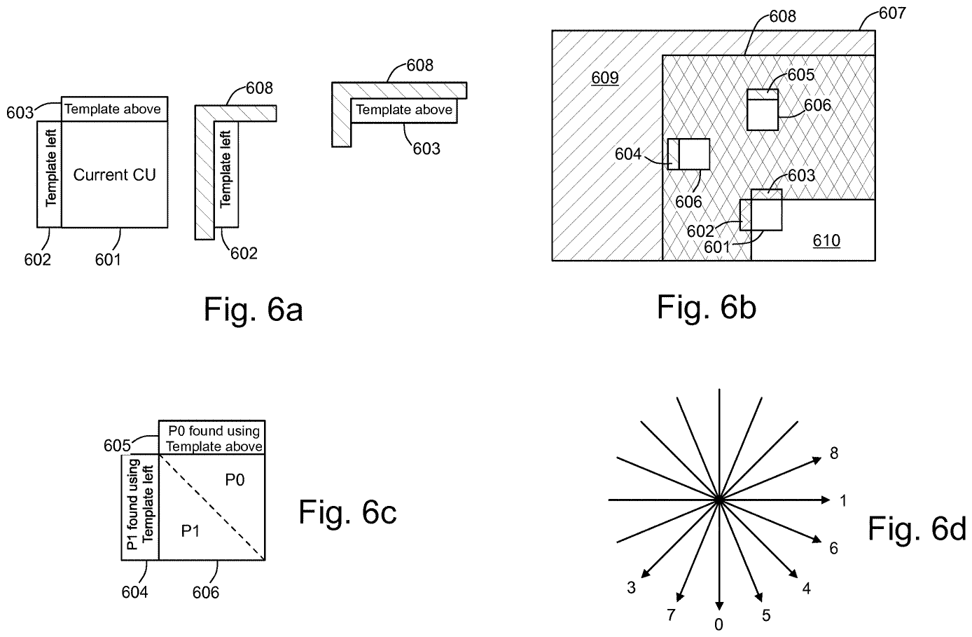

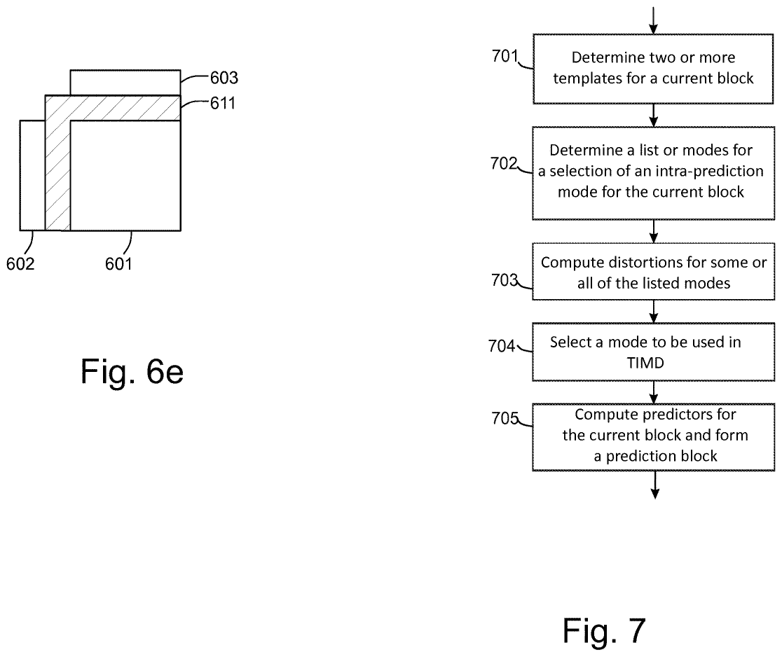

In the following, a method according to an embodiment will be described in more detail with reference to FIGS. 5, 6a to 6e and the flow diagram of FIG. 7. A method operating according to an embodiment comprises dividing (block 701 in FIG. 7) the area in a surrounding of a current block 601 into a number of at least two templates 602, 603, where a template is a region formed of already reconstructed samples. Each template 602, 603 is at a specific location with respect to the current block 601. Different templates may be considered with different pre-defined heights and widths.

FIG. 6a illustrates a current block (a coding unit CU) 601 for which a template-based intra prediction derivation will be performed. In this example there are two templates: a first template 602 on the left side of the current block 601 and a second template 603 above the current block 601. It should be noted, however, that also more than two templates could be used. The size of the first template 602 and/or the second template 603 may depend on the size of the current block 601 but may also be at least partly independent on the size of the current block 601. As an example, the height and width of a given template may be inferred from characteristics of the current block. As an example, the weight and/or height of a template may depend on the width and height of the current block. For example, the height of the first template 601 may be the same as the height of the current block 601 and the width of the second template 603 may be the same than the width of the current block 601. The width of the first template 601 may one or two columns of pixels or may be wider, and the height of the second template 603 may be one or two rows of pixels or may be higher.

Already reconstructed pixels (samples) in the surrounding of a template are used as reference samples. The number of reference samples to use may depend on the specific template, and/or on the template height and/or width, and/or on characteristics of the current block. As an example, the reference samples 608 as illustrated in FIG. 6a may be used. When already reconstructed samples are not available, these may be replaced by means of substitution with a pre-defined value, or by means of sample replication, or by means of mirroring the available reference samples, or by means of other padding techniques.

FIG. 6b illustrates an example of a picture or a frame 607 to be encoded/decoded. The already encoded or reconstructed pixels of the picture or frame 607 are illustrated with the hashed area 609 and pixels which are not yet encoded or reconstructed are illustrated with the white area 610. The current block is referred with the reference 601 within the area 610. For the template-based intra mode derivation of the current block 601 a search area 608 may be defined comprising already reconstructed pixels. In FIG. 6b the search area 608 is drawn to cover a large part of the frame 607 to illustrate the principle but in practical solutions the search area 608 may be much smaller. Furthermore, the location of the search area 608 may be different for different blocks to be intra-predicted.

For a given template, a number of candidate intra-prediction modes are considered 702. FIG. 6d illustrates an example of available intra-prediction modes from which a subset of intra-prediction modes may be selected for each template. The candidate intra-prediction modes may depend on the intra-prediction modes used in neighboring blocks, and/or may depend on characteristics of the current block, and/or may depend on the specific template, and/or may depend on the intra-prediction modes selected for other templates, and/or may depend on the modes included in a Most Probable Modes (MPM) list, where the MPM list may be computed. As an example, the list of candidate intra modes for a given template may depend on the location of a template with respect to the current block. As an example, the list of candidate intra modes for a given template may include modes that are similar to the intra prediction mode selected for a different template. As an example, if an intra-prediction directional mode was selected for a template, the list of candidate intra prediction modes may include directional modes that are close to that selected directional mode. As an example, in order to prevent the same intra-prediction mode from being selected in multiple templates, the list of candidate intra modes for a given template may exclude the intra prediction mode that was selected for another template. As an example, only vertical directional intra-prediction modes (e.g. the modes 0, 5 and 7 of FIG. 6d) may be considered for the second template 603 above the current block 601 in FIG. 6a, whereas only horizontal directional intra-prediction modes (e.g. the modes 1, 6 and 8 of FIG. 6d) may be considered for the first template 602 to the left of the current block 601 in FIG. 6a. As an example, the list of candidate intra modes for a given template may depend on the usage of specific intra-prediction techniques on the current block. As an example, specific intra-prediction modes may be prevented from being included in the candidate list depending on block parameters. As an example, a planar mode may be prevented from being included in the candidate list if a Multiple reference line coding is being used for intra-prediction in the current block. Other methods for forming a list of candidate intra-prediction modes for a given template may be considered.

When the candidate intra-prediction mode list has been obtained for a template, a search is performed among the modes in the list to obtain selected intra-prediction mode(s) for the specific template. Each mode in a list of candidate intra-prediction modes is tested or modes in the list may be tested or skipped, where testing or skipping a mode may depend on parameters obtained during the search, and/or on characteristics of the block, and/or on the template. Additional modes not originally present in the list may be tested as well, where modes which will be tested may depend on parameters obtained during the search. As an example, intra directional modes with directions close to modes in the list may be tested, where testing of these modes may depend on parameters computed during the search.

When testing a given intra-prediction mode, a predictor is computed for the template. FIG. 6a illustrates an example of a search area 608 for the computation of the predictor for the template to the left and for the template above the current block 601. FIG. 6b, explained above, illustrates another example where the search areas are farther away from the current block 601.

According to an embodiment, a first predictor 604 is searched for the first template 602 and a second predictor 605 is searched for the second template 603 within the search area 608. This may be performed, for example, so that a similar region of pixels than the first template 602 is selected within the search area as the first predictor 604 and, correspondingly, a similar region of pixels than the second template 603 is selected within the search area as the second predictor 605. The first predictor 604 obtained by testing a given intra-prediction mode is compared with the samples extracted from the first template 602 and the second predictor 605 obtained is compared with the samples extracted from the second template 603. In the comparison a measure of a first distortion between the first template 602 and the first predictor 604 and a measure of a second distortion between the second template 603 and the second predictor 605 may be computed 703.

The distortion value may be computed between pixel values of the predictor 604, 605 and pixel values of the template 602, 603. The computation may be repeated for other modes of the list of modes to obtain a set of predictors 604, 605 and, accordingly, a set of distortions. Such procedure may be repeated for a number of different locations of the predictors and a selection 704 of the predictor 604, 605 for the template 602, 603 is made among the different alternatives of potential predictors based on the computed distortions. For example, the distortion may be calculated as a sum of absolute differences (SAD) between pixel values of a potential predictor and the corresponding pixel values of the template and that potential predictor which produces the smallest SAD value is selected as the predictor for the template. As another example, a Sum of Absolute Transformed Differences (SATD) may be used as a distortion metric.

The distortions obtained on each template 602, 603 may be scaled, where the scaling may depend on the number of samples belonging to each of the templates. Other types of scaling may be considered. Other types of distortion metrics may also be considered. Advantageously, the distortion metric may be a combination of two distortion values where the first of the two values is based on Sum of Absolute Differences (SAD) and the second of the two values is based on Sum of Absolute Transformed Differences (SATD). The combination can further include scaling the value of either or both of the two and/or selecting the minimum of the scaled or non-scaled values. For example, the first value based on the SAD may be scaled up by a factor of two, whereas the second value may be used without scaling, and the minimum between the two values may be used to compute the distortion.

The distortions obtained testing intra-prediction modes to predict the samples in a given template 602, 603 are used to select one or more TIMD modes for a template 602, 603. As an example, one mode at a minimum distortion may be selected for a template 602, 603. As an example, one mode at a minimum SATD may be selected for a template 602, 603.

The selection of the intra-prediction modes for a given template may also depend on the intra-prediction modes obtained for the other templates. As an example, in case the mode at minimum distortion for the template 602 is equal to the mode at minimum distortion for the template 603, then a different mode may be selected for one of the two templates 602, 603. As an example, the distortions obtained on the template 602 and the template 603 may be compared one with the other, and the mode for the template with larger distortion may be substituted with a different mode. As an example, the mode at second minimum distortion may be used to substitute the mode at minimum distortion for a template. In other words, if, for example, it has been determined that the mode selected for the template 602 is such mode which provides minimum distortion for the template 602 and, correspondingly, it has been determined that the same mode provides minimum distortion also for the template 603, then a different mode may be selected for one of the templates 602, 603. For example, in such case the different mode for the template 603 may be that mode which have been determined to provide second minimum distortion for the template 603.

The intra-prediction may also be adapted or modified in accordance to the specific template 602, 603 being used and/or other characteristics of the current block 601. As an example, Position Dependent Prediction Compensation (PDPC) methods may be enabled, modified, or disabled depending on the template 602, 603.

The TIMD modes selected for the considered two or more templates 602, 603 are used to compute 705 predictors 604, 605 for the current block. The predictors may be computed depending on characteristics of the current block, and/or on block parameters. As an example, Planar prediction may be obtained using the Multiple reference line index, where the reference samples used to compute the predictor may depend on the Multiple reference line index.

In addition to predictors computed on the basis of template based intra-prediction, additional predictors may also be computed on the basis of pre-defined intra prediction modes, depending on characteristics of the block. As an example, in case the reference samples in a specific template are not available, for instance because the current block includes either at the top or left border of the picture, then a pre-defined intra-prediction mode may be used. As an example, the Planar prediction may be used. As an example, if the current block includes the top border of the frame, then instead of using the above template 603 to derive an intra prediction mode for the template above, the Planar mode may be used to derive a predictor. As another example, if the current block includes the left border of the frame, then instead of using the left template 602 to derive an intra prediction mode for the template on the left, the Planar mode may be used to derive a predictor.

The predictors 604, 605 are used to form a prediction block 606 for the current block 601, where the prediction block 606 may be obtained by combining the two or more predictors 604, 605 together. The combination of modes may happen, for example, by means of uniform blending. As an example, the weights used for blending may depend on the distortions computed for each TIMD mode on a template. As an example, higher weights may be assigned to predictors corresponding to lower distortions.

The predictors 604, 605 may also be combined by means of sample-based blending, where weights may depend on the location of each sample within the block. Weights may also depend on the distortions computed for each TIMD mode on a template. Weights may also depend on the template used to compute a TIMD mode. As an example, it is assumed that two templates are being used, and that one TIMD mode m_0 is selected from the above template 603, and one TIMD mode m_1 is selected from the left template 602, and finally denote as P_0 and P_1 the predictors obtained performing intra-prediction to predict the current block using modes m_0 and m_1, respectively. This is illustrated in FIG. 6c in which the predictor P0 is obtained based on the above template 603 and the predictor P1 is obtained based on the left template 602. Then, a final predictor P (606 in FIG. 6c) for the current block 601 may be obtained as:

$$P ( x , y ) = w 1 ( x , y ) P 1 ( x , y ) + w 0 ( x , y ) P 0 ( x , y )$$

where P_i(x,y) refers to pixel in predictor P_i at location (x,y).

The weights for a given predictor w_i(x,y) may depend on the location (x,y). The weights w_i(x,y) may also depend on the templates used to compute m_0 and m_1. As an example, assuming a block of size H×W where W is the width and H is the height, then the weights may be determined as:

$$w 0 ( x , y ) = 0.5 + x / 2 W - y / 2 H$$

$$w 1 ( x , y ) = 1 - w 0 ( x , y )$$

which corresponds to assigning higher weights to predictor P_0 at locations in the block closer to the above template, and conversely assigning higher weights to predictor P_1 at locations in the block closer to the left template. An integer-precision representation of the weights may also be considered. A division-free representation of the weights may also be considered, where divisions may be substituted with multiplications and binary shifts.

The weights got a given predictor w_i(x,y) may also depend on the distortions computed for each TIMD mode on a template, and/or on how these distortions compare to each other. As an example, it can be assumed that dist_0 and dist_1 are the distortions obtained when determining m_0 and m_1 resulting respectively in predictors P_0 and P_1. These distortions may be scaled, as an example, each distortion obtained for a given mode determined on a specific template may be scaled by the number of samples in that template. As an example, two parameters may then be defined as:

$$Weight\_ 0 = dist\_ 1 / ( dist\_ 0 + dist\_ 1 )$$

$$Weight\_ 1 = dist\_ 0 / ( dist\_ 0 + dist\_ 1 )$$

The distortions, or parameters computed in dependence to the distortions, may be used to determine the weights w_i(x,y) for predictor P_i. As an example, higher weights may be used for predictors with lower distortion. As another example, higher weights may be assigned to the predictor P0, if Weight_0 is greater than Weight_1.

The weights w_i(x,y) for the predictor P_i may be computed in dependence to specifically defined parameters factorX and factorY which depend on the distortions. As an example, it is assumed that two templates are being used, and that one TIMD mode m_0 is selected from the above template 603, and one TIMD mode m_1 is selected from the left template 602, and that the parameters factorX and factory may be determined as

$$factorX = 2 , if Weight\_ 1 < ( Weight 1 + Weight\_ 2 ) / 4 , or$$

$$factorX = 1 otherwise$$

Similarly:

$$factorY = 2 , if Weight\_ 0 < ( Weight 1 + Weight\_ 2 ) / 4 , or$$

$$factorX = 1 otherwise$$

Then, as an example, the weights w_i(x,y) for the predictor P_i may be computed as:

$$w 0 ( x , y ) = 0.5 + ( x * factorX ) / 2 W - ( y * factorY ) / 2 H$$

$$w 1 ( x , y ) = 1 - w 0 ( x , y )$$

Usage of this method to compute a prediction for the current block may be signalled in the bitstream by means of a flag. The presence of the flag in the bitstream may depend on parsing of other signalled TIMD parameters. As an example, the presence of the flag may depend on whether a flag indicating usage of TIMD is parsed from the bitstream for the current block. For example, if the flag indicates usage of TIMD, then the bitstream comprises the flag which indicates whether the method to compute a prediction for the current block is used or not, and, respectively, if the flag indicates that TIMD is not used, then the bitstream does not comprise the flag.

A method operating according to an embodiment may also form predictors for the current block using TIMD techniques, where the predictors are combined together by means of blending, where sample-based blending is used, where weights may depend on the location of each sample within the block. The weights may depend on other TIMD parameters such as the distortion between the predictor obtained on a template and the template. The weight may depend on the distortion computed between a predictor obtained on a template and the template, where a number of at least two templates are considered, where a predictor is obtained for each template using intra-prediction, where a distortion is computed between a predictor and a corresponding template. Usage of sample-based blending may be inferred from characteristics of the block.

A method operating according to an embodiment produces an intra-prediction for a given block, where at least two intra-prediction modes are considered for usage to predict the current block 601. As an example, the considered intra-prediction modes may be selected following a TIMD search using a master template 611 (FIG. 6e). As an example, two intra-prediction modes may be selected as the two modes with minimum distortion when searching among a number of candidate intra-prediction modes on the master template 611. A number of at least two additional templates 602, 603 is then considered, where each template 602, 603 is at a specific location with respect to the current block 601, where the additional templates 602, 603 may or may not overlap with the master template 611. For each additional template 602, 603, TIMD parameters are computed depending on the considered intra-prediction modes. As an example, a distortion is computed for each template 602, 603 for each considered intra-prediction mode. The distortion is obtained by computing a predictor 604, 605 on the current template 602, 603 using the intra-prediction mode, and then computing the distortion between the predictor 604, 605 and the template 602, 603.

The TIMD parameters are used to form a prediction block 606 for the current block 601. As an example, the TIMD parameters are used to determine the type of blending to use to form a final prediction block 606 for the current block 601. As an example, the distortions computed for each mode for each template 602, 603, 611 may be used to infer whether sample-based blending should be used to predict the current block 601. As an example, if the distortion obtained for a given mode on a given template is much smaller than the distortion obtained for the same mode on a different template, then sample-based weighting may be inferred.

Sample-based weights are determined based on the location of each sample within the block. Weights may also depend on the TIMD parameters computed on each template 602, 603. As an example, if the distortion obtained for a given mode on a given template is much smaller than the distortion obtained for the same mode on a different template, then higher weights may be assigned to the predictor obtained with that mode to samples at locations closer to the template.

A method operating according to an embodiment produces an intra-prediction for a given block 601, where at least two intra-prediction modes are considered for usage to predict the current block 601. As an example, the considered intra-prediction modes may be selected following a TIMD search using the master template 611. As an example, two intra-prediction modes may be selected as the two modes with minimum distortion when searching among a number of candidate intra-prediction modes on the master template 611. A number of at least two additional templates 602, 603 is then considered, where each template 602, 603 is at a specific location with respect to the current block 601, where the additional templates 602, 603 may or may not overlap with the master template 611. For each additional template 602, 603 a list of candidate intra-prediction modes is considered. A search is performed among the modes in the list of candidate intra-prediction modes. As an example, a list of MPM modes may be used as list of candidate intra-prediction modes. Additional modes may be added to the list depending on parameters determined during the search.

A list of TIMD modes is selected following the search performed on a given template. As an example, the mode at minimum distortion may be selected from the list for each template.

The list of TIMD modes is used to determine the type of blending to use to form a final prediction for the current block using the considered intra-prediction modes. As an example, the considered TIMD modes may be compared with the modes in the TIMD list obtained for a given template. As an example, if a mode is present in a list for a template, and that same mode is not present in a list obtained for other templates, then usage of sample-based blending may be inferred.

Sample-based weights are determined based on the location of each sample within the block. Weights may also depend on the presence of a given intra-prediction mode in a given list obtained on a specific template. As an example, if a mode is present in a template, then higher weights may be assigned to the predictor obtained with that mode to samples at locations closer to the template.

It should be noted here that similar operations presented above may be performed by an encoder 530, e.g. in a decoding loop of the encoder (302, 304; 402, 404 in FIG. 4), and in a decoder 540 because the decoder and the decoding loop of the encoder use reconstructed samples and optionally the search area may use some samples not yet available (reconstructed) but which are derived by some kind of padding operation.

FIG. 5 illustrates an example of operation of an encoder 530 and a decoder 540 based on the above embodiments. A block of reconstructed samples is input (520). A list of TIMD modes are defined 530 and provided to distortion calculation circuitry 532. A mode selection circuitry 531 performs mode selection and the distortion calculation circuitry 532 may compute a new distortion value or values based on the selected mode, as explained above. A finally selected mode is provided to the intra predictor 533 for performing the intra prediction to the current block 601. The quantizer 534 and the entropy encoder 535 perform quantization and entropy encoding, respectively, and a bitstream 536 is formed.

The bitstream 536 is received by the decoder 540 in which an entropy decoder 541 performs entropy decoding and a dequantizer 542 dequantizes the decoded information. The list of TIMD modes is defined 543 when the decoder 540 notices that a currently received block, or frame, is intra-predicted by utilizing template-based intra prediction derivations. Hence, distortion calculation 545, mode selection 544 and intra prediction 546 are performed accordingly.

The methods and the related embodiments can be implemented in different ways. For example, the order of operations described above can be changed or the operations can be interleaved in different ways. Also, different additional operations can be applied in different stages of the processing. For example, there may be additional filtering, scaling, mapping or other processing applied to the final or intermediate result of described operations. The final or intermediate result of the operations described above may also be further combined with results of other operations.

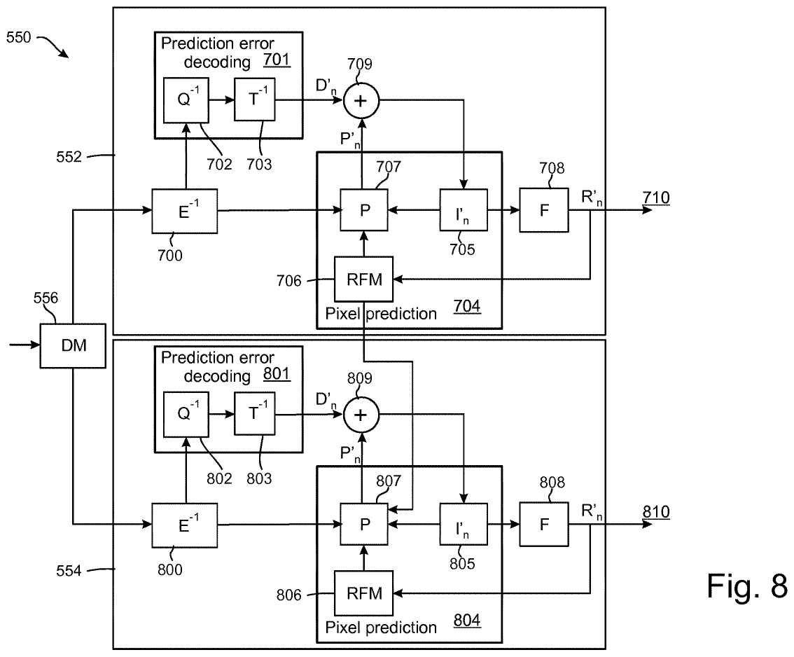

FIG. 8 shows a block diagram of a video decoder suitable for employing embodiments. FIG. 8 depicts a structure of a two-layer decoder, but it would be appreciated that the decoding operations may similarly be employed in a single-layer decoder.

The video decoder 550 comprises a first decoder section 552 for a base layer and a second decoder section 554 a predicted layer. Block 556 illustrates a demultiplexer for delivering information regarding base layer pictures to the first decoder section 552 and for delivering information regarding predicted layer pictures to the second decoder section 554. Reference P′n stands for a predicted representation of an image block. Reference D′n stands for a reconstructed prediction error signal. Blocks 704, 804 illustrate preliminary reconstructed images (I′n). Reference R′n stands for a final reconstructed image. Blocks 703, 803 illustrate inverse transform (T-1). Blocks 702, 802 illustrate inverse quantization (Q1). Blocks 701, 801 illustrate entropy decoding (E-1). Blocks 705, 805 illustrate a reference frame memory (RFM). Blocks 706, 806 illustrate prediction (P) (either inter prediction or intra prediction). Blocks 707, 807 illustrate filtering (F). Blocks 708, 808 may be used to combine decoded prediction error information with predicted base layer/predicted layer images to obtain the preliminary reconstructed images (I′n). Preliminary reconstructed and filtered base layer images may be output 709 from the first decoder section 552 and preliminary reconstructed and filtered base layer images may be output 809 from the first decoder section 554.

Herein, the decoder should be interpreted to cover any operational unit capable to carry out the decoding operations, such as a player, a receiver, a gateway, a demultiplexer and/or a decoder.

As a further aspect, there is provided an apparatus comprising: at least one processor and at least one memory, said at least one memory stored with code thereon, which when executed by said at least one processor, causes the apparatus to perform at least: decoding a set of transform coefficients associated with a transform block; determining if a dual transform is applied to said transform block, and if affirmative; performing a first transform to the set of decoded transform coefficients and generate a first set of output values; performing a second transform using said first set of output values as input to said second transform and generate a second set of output values; and using the second set of output values as the output of the dual transform.

Such an apparatus further comprises code, stored in said at least one memory, which when executed by said at least one processor, causes the apparatus to perform one or more of the embodiments disclosed herein.

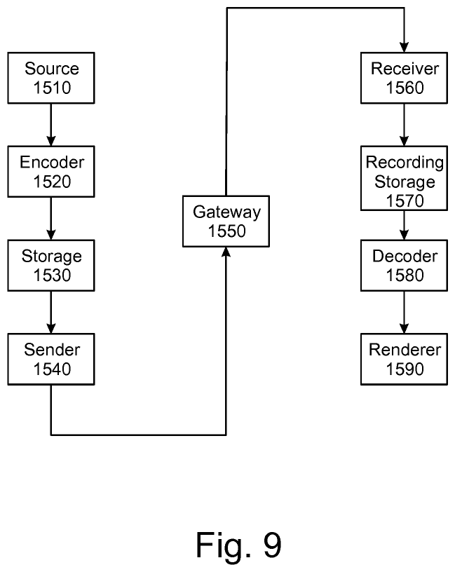

FIG. 9 is a graphical representation of an example multimedia communication system within which various embodiments may be implemented. A data source 1510 provides a source signal in an analog, uncompressed digital, or compressed digital format, or any combination of these formats. An encoder 1520 may include or be connected with a pre-processing, such as data format conversion and/or filtering of the source signal. The encoder 1520 encodes the source signal into a coded media bitstream. It should be noted that a bitstream to be decoded may be received directly or indirectly from a remote device located within virtually any type of network. Additionally, the bitstream may be received from local hardware or software. The encoder 1520 may be capable of encoding more than one media type, such as audio and video, or more than one encoder 1520 may be required to code different media types of the source signal. The encoder 1520 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the figure only one encoder 1520 is represented to simplify the description without a lack of generality. It should be further understood that, although text and examples contained herein may specifically describe an encoding process, one skilled in the art would understand that the same concepts and principles also apply to the corresponding decoding process and vice versa.

The coded media bitstream may be transferred to a storage 1530. The storage 1530 may comprise any type of mass memory to store the coded media bitstream. The format of the coded media bitstream in the storage 1530 may be an elementary self-contained bitstream format, or one or more coded media bitstreams may be encapsulated into a container file, or the coded media bitstream may be encapsulated into a Segment format suitable for DASH (or a similar streaming system) and stored as a sequence of Segments. If one or more media bitstreams are encapsulated in a container file, a file generator (not shown in the figure) may be used to store the one more media bitstreams in the file and create file format metadata, which may also be stored in the file. The encoder 1520 or the storage 1530 may comprise the file generator, or the file generator is operationally attached to either the encoder 1520 or the storage 1530. Some systems operate “live”, i.e. omit storage and transfer coded media bitstream from the encoder 1520 directly to the sender 1540. The coded media bitstream may then be transferred to the sender 1540, also referred to as the server, on a need basis. The format used in the transmission may be an elementary self-contained bitstream format, a packet stream format, a Segment format suitable for DASH (or a similar streaming system), or one or more coded media bitstreams may be encapsulated into a container file. The encoder 1520, the storage 1530, and the server 1540 may reside in the same physical device or they may be included in separate devices. The encoder 1520 and server 1540 may operate with live real-time content, in which case the coded media bitstream is typically not stored permanently, but rather buffered for small periods of time in the content encoder 1520 and/or in the server 1540 to smooth out variations in processing delay, transfer delay, and coded media bitrate.

The server 1540 sends the coded media bitstream using a communication protocol stack. The stack may include but is not limited to one or more of Real-Time Transport Protocol (RTP), User Datagram Protocol (UDP), Hypertext Transfer Protocol (HTTP), Transmission Control Protocol (TCP), and Internet Protocol (IP). When the communication protocol stack is packet-oriented, the server 1540 encapsulates the coded media bitstream into packets. For example, when RTP is used, the server 1540 encapsulates the coded media bitstream into RTP packets according to an RTP payload format. Typically, each media type has a dedicated RTP payload format. It should be again noted that a system may contain more than one server 1540, but for the sake of simplicity, the following description only considers one server 1540.

If the media content is encapsulated in a container file for the storage 1530 or for inputting the data to the sender 1540, the sender 1540 may comprise or be operationally attached to a “sending file parser” (not shown in the figure). In particular, if the container file is not transmitted as such but at least one of the contained coded media bitstream is encapsulated for transport over a communication protocol, a sending file parser locates appropriate parts of the coded media bitstream to be conveyed over the communication protocol. The sending file parser may also help in creating the correct format for the communication protocol, such as packet headers and payloads. The multimedia container file may contain encapsulation instructions, such as hint tracks in the ISOBMFF, for encapsulation of the at least one of the contained media bitstream on the communication protocol.

The server 1540 may or may not be connected to a gateway 1550 through a communication network, which may e.g. be a combination of a CDN, the Internet and/or one or more access networks. The gateway may also or alternatively be referred to as a middle-box. For DASH, the gateway may be an edge server (of a CDN) or a web proxy. It is noted that the system may generally comprise any number gateways or alike, but for the sake of simplicity, the following description only considers one gateway 1550. The gateway 1550 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. The gateway 1550 may be a server entity in various embodiments.

The system includes one or more receivers 1560, typically capable of receiving, de-modulating, and de-capsulating the transmitted signal into a coded media bitstream. The coded media bitstream may be transferred to a recording storage 1570. The recording storage 1570 may comprise any type of mass memory to store the coded media bitstream. The recording storage 1570 may alternatively or additively comprise computation memory, such as random access memory. The format of the coded media bitstream in the recording storage 1570 may be an elementary self-contained bitstream format, or one or more coded media bitstreams may be encapsulated into a container file. If there are multiple coded media bitstreams, such as an audio stream and a video stream, associated with each other, a container file is typically used and the receiver 1560 comprises or is attached to a container file generator producing a container file from input streams. Some systems operate “live,” i.e. omit the recording storage 1570 and transfer coded media bitstream from the receiver 1560 directly to the decoder 1580. In some systems, only the most recent part of the recorded stream, e.g., the most recent 10-minute excerption of the recorded stream, is maintained in the recording storage 1570, while any earlier recorded data is discarded from the recording storage 1570.

The coded media bitstream may be transferred from the recording storage 1570 to the decoder 1580. If there are many coded media bitstreams, such as an audio stream and a video stream, associated with each other and encapsulated into a container file or a single media bitstream is encapsulated in a container file e.g. for easier access, a file parser (not shown in the figure) is used to decapsulate each coded media bitstream from the container file. The recording storage 1570 or a decoder 1580 may comprise the file parser, or the file parser is attached to either recording storage 1570 or the decoder 1580. It should also be noted that the system may include many decoders, but here only one decoder 1570 is discussed to simplify the description without a lack of generality

The coded media bitstream may be processed further by a decoder 1570, whose output is one or more uncompressed media streams. Finally, a renderer 1590 may reproduce the uncompressed media streams with a loudspeaker or a display, for example. The receiver 1560, recording storage 1570, decoder 1570, and renderer 1590 may reside in the same physical device or they may be included in separate devices.

A sender 1540 and/or a gateway 1550 may be configured to perform switching between different representations e.g. for switching between different viewports of 360-degree video content, view switching, bitrate adaptation and/or fast start-up, and/or a sender 1540 and/or a gateway 1550 may be configured to select the transmitted representation(s). Switching between different representations may take place for multiple reasons, such as to respond to requests of the receiver 1560 or prevailing conditions, such as throughput, of the network over which the bitstream is conveyed. In other words, the receiver 1560 may initiate switching between representations. A request from the receiver can be, e.g., a request for a Segment or a Subsegment from a different representation than earlier, a request for a change of transmitted scalability layers and/or sub-layers, or a change of a rendering device having different capabilities compared to the previous one. A request for a Segment may be an HTTP GET request. A request for a Subsegment may be an HTTP GET request with a byte range. Additionally or alternatively, bitrate adjustment or bitrate adaptation may be used for example for providing so-called fast start-up in streaming services, where the bitrate of the transmitted stream is lower than the channel bitrate after starting or random-accessing the streaming in order to start playback immediately and to achieve a buffer occupancy level that tolerates occasional packet delays and/or retransmissions. Bitrate adaptation may include multiple representation or layer up-switching and representation or layer down-switching operations taking place in various orders.

A decoder 1580 may be configured to perform switching between different representations e.g. for switching between different viewports of 360-degree video content, view switching, bitrate adaptation and/or fast start-up, and/or a decoder 1580 may be configured to select the transmitted representation(s). Switching between different representations may take place for multiple reasons, such as to achieve faster decoding operation or to adapt the transmitted bitstream, e.g. in terms of bitrate, to prevailing conditions, such as throughput, of the network over which the bitstream is conveyed. Faster decoding operation might be needed for example if the device including the decoder 1580 is multi-tasking and uses computing resources for other purposes than decoding the video bitstream. In another example, faster decoding operation might be needed when content is played back at a faster pace than the normal playback speed, e.g. twice or three times faster than conventional real-time playback rate.

In the above, some embodiments have been described with reference to and/or using terminology of HEVC. It needs to be understood that embodiments may be similarly realized with any video encoder and/or video decoder.

In the above, where the example embodiments have been described with reference to an encoder, it needs to be understood that the resulting bitstream and the decoder may have corresponding elements in them. Likewise, where the example embodiments have been described with reference to a decoder, it needs to be understood that the encoder may have structure and/or computer program for generating the bitstream to be decoded by the decoder. For example, some embodiments have been described related to generating a prediction block as part of encoding. Embodiments can be similarly realized by generating a prediction block as part of decoding, with a difference that coding parameters, such as the horizontal offset and the vertical offset, are decoded from the bitstream than determined by the encoder.

The embodiments described above describe the codec in terms of separate encoder and decoder apparatus in order to assist the understanding of the processes involved. However, it would be appreciated that the apparatus, structures and operations may be implemented as a single encoder-decoder apparatus/structure/operation. Furthermore, it is possible that the coder and decoder may share some or all common elements.

Although the above examples describe embodiments operating within a codec within an electronic device, it would be appreciated that the invention as defined in the claims may be implemented as part of any video codec. Thus, for example, embodiments may be implemented in a video codec which may implement video coding over fixed or wired communication paths.

Thus, user equipment may comprise a video codec such as those described in embodiments above. It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

In the following some examples will be provided.

A method for decoding encoded video data, the method operable to predict samples of a block of video sample data, the method comprising:
dividing the area in the surrounding of the current block into a number of at least two templates formed of already reconstructed samples, at specific locations with respect to the block of video sample data;
for each template, determining one or more intra-prediction modes; and
forming a prediction for the block of video sample data using the determined intra-prediction modes.

A method for decoding encoded video data, the method operable to predict samples of a block of video sample data, the method comprising:
determining intra-prediction modes by means of template-based intra prediction derivation;
computing at least two predictors of the block of video sample data based on the determined intra-prediction modes; and
combining the least two predictors together using blending to form a prediction for the block, where blending is performed using weights, where sample-based weights are used.

A method for decoding encoded video data, the method operable to predict samples of a block of video sample data, the method comprising:
determining intra-prediction modes to predict the current block;
dividing the area in the surrounding of the current block into a number of at least two templates formed of already reconstructed samples, at specific locations with respect to the block of video sample data;
for each template and for each determined intra-prediction mode, determining parameters; and
forming a prediction for the block of video sample data using the determined intra-prediction modes and the parameters specific to each template,

A method for decoding encoded video data, the method operable to predict samples of a block of video sample data, the method comprising:
determining intra-prediction modes to predict the current block;
dividing the area in the surrounding of the current block into a number of at least two templates formed of already reconstructed samples, at specific locations with respect to the block of video sample data;
for each template, determining intra-prediction modes specific to each template;
using the intra-prediction modes specific to each template to determine blending parameters for the current block; and
forming a prediction for the block of video sample data using the determined intra-prediction modes and the determined blending parameters.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention.

1-17. (canceled)

18. An apparatus comprising
at least one processor; and
at least one memory storing instructions that, when executed by the at least one processor, cause the apparatus at least to:
decode encoded video data to obtain reconstructed samples of a picture;
use the reconstructed samples to intra-predict a current block of the picture;
divide an area in a surrounding of the current block into at least two templates formed of the reconstructed samples at specific locations with respect to the current block;
determine, for each template, one or more intra-prediction modes by template-based intra mode derivation;
compute at least two predictors of the current block based on the determined intra-prediction modes; and
combine the at least two predictors together using blending to form a prediction block for the current block, wherein to perform combining, the apparatus is further caused to use sample-based weights.

19. The apparatus according to claim 18, wherein the apparatus is further caused to:
determine one or more parameters for each template and for each determined intra-prediction mode; and
form the prediction block for the current block using the determined intra-prediction modes and the one or more parameters corresponding to each template.

20. The apparatus according to claim 19, wherein the one or more parameters for each template comprise distortions or costs determined by template-based intra mode derivation.

21. The apparatus according to claim 18, wherein the apparatus is further caused to: compute the sample-based weights based on one or more parameters for each template determined by the template-based intra mode derivation.

22. The apparatus according to claim 18, wherein the apparatus is further caused to compute the sample-based weights based on the at least two templates used to determine the intra-prediction modes.

23. The apparatus according to claim 18, wherein the apparatus is further caused to:
scale or normalize one or more parameters based on characteristics of the at least two templates.

24. The apparatus according to claim 18, wherein the apparatus is further caused to:
infer the usage of sample-based weighting based on the intra-prediction modes determined based on at least one of:
a template-based intra prediction; or
on characteristics of the current block.

25. The apparatus according to claim 18, wherein the apparatus is further caused to:
use the intra-prediction modes specific to each template to determine blending one or more parameters for the current block; and
form the prediction block for the current block using the determined intra-prediction modes and the determined blending parameters, in addition to the at least two predictors.

26. The apparatus according to claim 18, wherein the apparatus is further caused to:
determine a number of candidate intra-prediction modes for the template based on one or more of the following:
the intra-prediction modes used in neighboring blocks,
characteristics of the current block,
a specific template,
the intra-prediction modes selected for a different template, or
modes included in a Most Probable Modes (MPM) list.

27. The apparatus according to claim 18, wherein the apparatus is further caused to:
determine a number of candidate intra-prediction modes for the template based on a location of the template with respect to the current block.

28. The apparatus according to claim 26, wherein to select an intra-prediction mode for the at least two templates the apparatus is further caused perform the following for each of the at least two templates:
compute a set of predictors using different intra-prediction modes;
compare the predictors with samples of the at least two templates to define a distortion for each predictor; and
select that predictor for the at least two templates which produced a smallest distortion.

29. The apparatus according to claim 28, wherein the apparatus is further caused to:
combine the selected predictors to form the prediction block.
weight samples of the selected predictors based on a determined criteria.

30. The apparatus according to claim 29, wherein the determined criteria comprises one or more of the following:
a location of a sample in the prediction block;
the template used to determine the intra-prediction modes;
a distortion between the predictor obtained on a template and the template;
distortions computed for each template-based intra mode derivation (TIMD) mode on a template, and/or on how the distortions compare to each other.

31. The apparatus according to claim 29, wherein the apparatus is further caused to:
select an intra-prediction mode for one template of the at least two templates based on the intra-prediction mode selected for another template of the at least two templates.

32. A method comprising:
decoding encoded video data to obtain reconstructed samples of a picture;
using the reconstructed samples to intra-predict a current block of the picture;
dividing an area in a surrounding of the current block into at least two templates formed of the reconstructed samples at specific locations with respect to the current block;
determining for each template one or more intra-prediction modes by template-based intra mode derivation;
computing at least two predictors of the current block based on the determined intra-prediction modes; and
combining the at least two predictors together using blending by sample-based weights to form a prediction block for the current block.

33. The method according to claim 32, further comprising:
determining one or more parameters for each template and for each determined intra-prediction mode; and
forming the prediction block for the current block using the determined intra-prediction modes and the one or more parameters corresponding to each template.

34. The method according to claim 33, wherein the one or more parameters for each template comprise distortions or costs determined by template-based intra mode derivation.

35. The method according to claim 32, further comprising:
computing the sample-based weights depending on the one or more parameters for each template determined by the template-based intra mode derivation.

36. The method according to claim 32, further comprising
computing the sample-based weights based on specific templates used to determine the intra-prediction modes.

37. The method according to claim 32, further comprising:
scaling or normalizing one or more parameters based on characteristics of the at least two templates.
